(19) United States
(12) Patent Application Publication
(10) Pub. No.: US 2007/0061728 A1
(43) Pub. Date: Mar. 15, 2007

(54) Time approximation for text location in video editing method and apparatus

(76) Inventors: Leonard Sitomer, Wellesley, MA (US); Patrick O'Connor, Groton, MA (US); Stephen J. Reber, Brookline, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/516,458

(22) Filed: Sep. 5, 2006

Related U.S. Application Data
(60) Provisional application No. 60/714,950, filed on Sep. 7, 2005.

(51) Int. Cl. G11B 27/00; G10L 21/00

(52) U.S. Cl. 715/723; 704/278

(57) ABSTRACT

A time approximator for use in video editing is disclosed. The time approximator estimates time location in the media file/video data domain of a user-selected word or text unit in the text script transcription of the corresponding audio of the video data. During video editing, the time approximator calculates and displays the estimated time location of user-selected text to assist the user-editor in cross referencing between the beginning and ending of user-selected passage statements in the text script and the corresponding video data in a rough cut or subsequent video data work. The time approximator enables simultaneous editing of text and video by the selection of either source component.

### RELATED APPLICATIONS

This application claims the benefit of U.S. Provisional Application No. 60/714,950 filed Sep. 7, 2005, the entire teachings of which are incorporated herein by reference.

### BACKGROUND OF THE INVENTION

Early stages of the video production process include obtaining interview footage and generating a first draft of edited video. Making a rough cut, or first draft, is a necessary phase in productions that include interview material. It is usually constructed without additional graphics or video imagery and used solely for its ability to create and coherently tell a story. It is one of the most critical steps in the entire production process and also one of the most difficult. It is common for a video producer to manage 25, 50, 100 or as many as 200 hours of source tape to complete a rough cut for a one hour program.

Current methods for developing a rough cut are fragmented and inefficient. Some producers work with transcripts of interviews, word process a script, and then perform a video edit. Others simply move their source footage directly into their editing systems where they view the entire interview in real time, choose their set of possible interview segments, then edit down to a rough cut.

Once a rough cut is completed, it is typically distributed to executive producers or corporate clients for review. Revisions requested at this time involve more video editing and more text editing. These revision cycles are very costly, time consuming and sometimes threaten project viability.

### SUMMARY OF THE INVENTION

Generally, the present invention addresses the problems of the prior art by providing a computer automated method and apparatus of video editing. In particular, the present invention provides a time approximation for text location. With such time approximation, features for enhancing video editing and especially editing of a rough cut are enabled.

In one embodiment, a first draft or rough cut is produced by video editing method and apparatus as follows. A transcription module receives subject video data. The video data includes corresponding audio data. The transcription module generates a working transcript of the corresponding audio data of the subject video data and associates portions of the transcript to respective corresponding portions of the subject video data. A host computer provides display of the working transcript to a user and effectively enables user selection of portions of the subject video data through the displayed transcript. An assembly member responds to user selection of transcript portions of the displayed transcript and obtains the respective corresponding video data portions. For each user selected transcript portion, the assembly member, in real time, (a) obtains the respective corresponding video data portion, (b) combines the obtained video data portions to form a resulting video work, and (c) displays a text script of the resulting video work. It is this resulting video work that is the “rough cut”.

The host computer provides display of the rough cut (resulting video work) and corresponding text script to the user for purposes of further editing. Preferably, the resulting text script and rough cut are simultaneously (e.g., side by side) displayed. The display of the rough cut is supported by the initial video data or a media file thereof. The displayed corresponding text script is formed of a series of passages. Further, each passage includes one or more statements. The user may further edit the rough cut by selecting a subset of the statements in a passage. The video editing apparatus enables a user to redefine (split or otherwise divide) passages.

In response to user selection of a subset of the passage statements, the present invention estimates the corresponding time location (e.g., frame, hour, minutes, seconds of elapsed time) in the media file (initial video data) of the beginning and ending of the user-selected passage statements. In a preferred embodiment, the present invention estimates time location, in the media file/video data domain, of a word (term or other text unit) in the text script as selected by the user. During editing activity, the present invention calculates and displays the estimated time location of user selected text to assist the user in cross-referencing between the beginning and ending of user selected passage statements in the text script and the corresponding video data in the rough cut.

The association of time locations in media files with corresponding text locations in script text enables the user to edit media files by the selection of text passages. The invention time approximator enables simultaneous editing of text and video by the selection of either source component.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view of a computer network environment in which embodiments of the present invention may be practiced.

FIG. 2 is a block diagram of a computer from one of the nodes of the network of FIG. 1.

FIG. 3 is a flow diagram of video editing method and system utilizing an embodiment of the present invention.

FIGS. 4a-4c are schematic views of time approximation for text location in one embodiment of the present invention.

FIG. 5 is a schematic illustration of a graphical user interface in one embodiment of the present invention.

### DETAILED DESCRIPTION OF THE INVENTION

A description of preferred embodiments of the invention follows.

The present invention provides a media/video time approximation for text location in a transcript of the audio in a video or multimedia work. More specifically, one of the uses of the invention media time location technique is for editing video by text selections and for editing text by video selections.

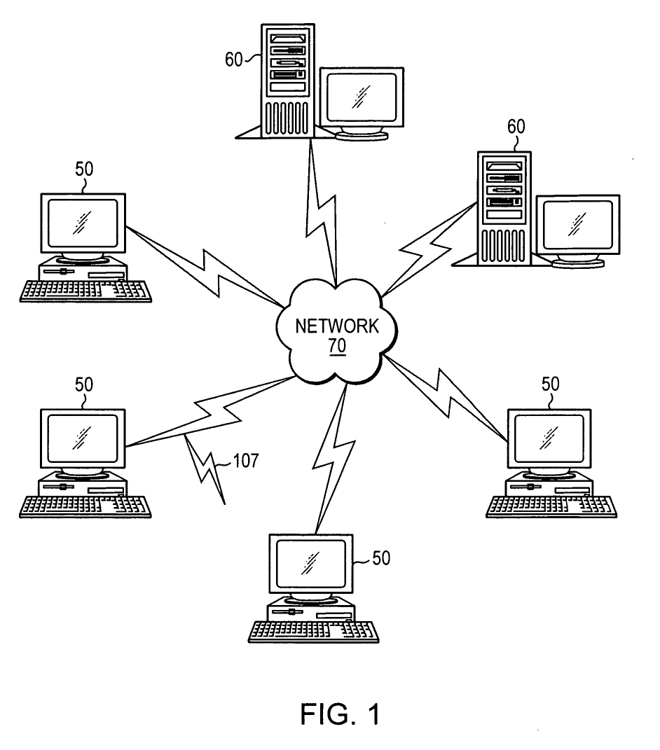

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

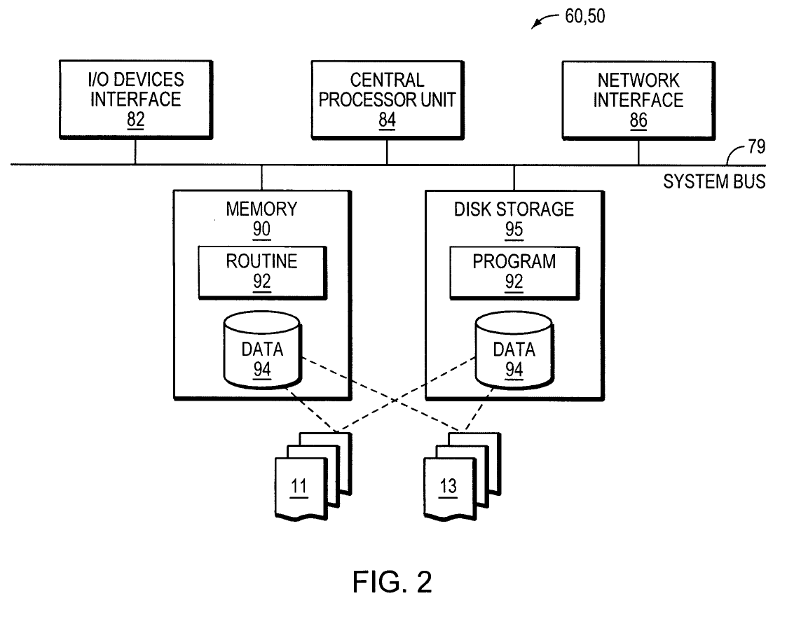

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions used to implement an embodiment of the present invention (e.g., Program Routines 92 and Data 94, detailed later). Disk storage 95 provides non-volatile storage for computer software instructions 92 and data 94 used to implement an embodiment of the present invention. Central processor unit 84 is also attached to system bus 79 and provides for the execution of computer instructions.

As will be made clear later, data 94 includes source video data files (or media files) 1 1 and corresponding working transcript files 13 (and related text script files 17). Working transcript files 13 are text transcriptions of the audio tracks of the respective video data 11.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92. In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

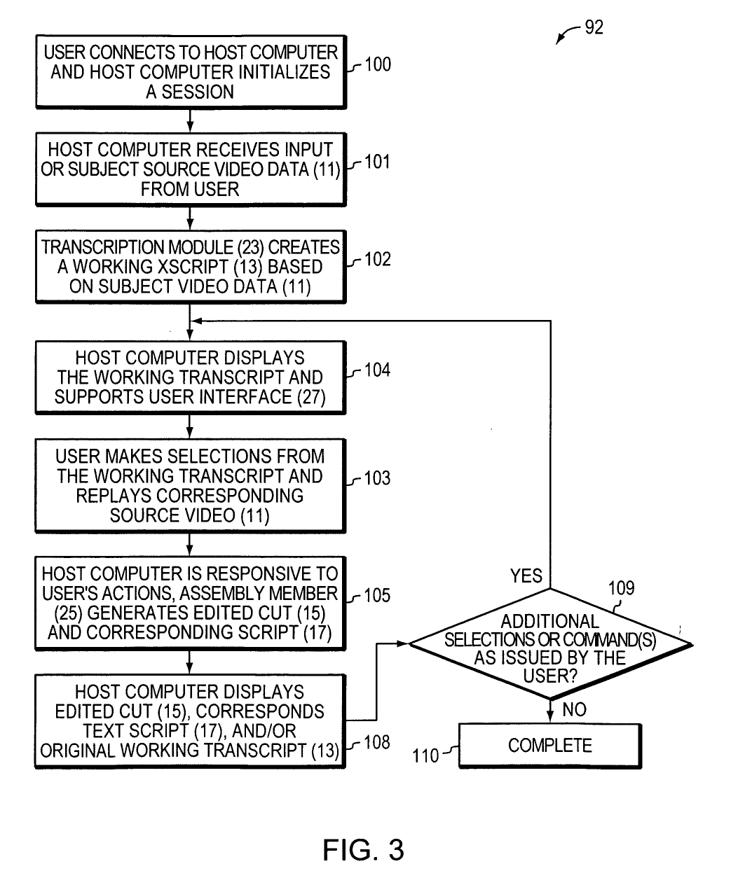

In one embodiment, a host server computer 60 provides a portal (services and means) for video editing and routine 92 implements the invention video editing system. Users (client computers 50) access the invention video editing portal through a global computer network 70, such as the Internet. Program 92 is preferably executed by the host 60 and is a user interactive routine that enables users (through client computers 50) to edit their desired video data. FIG. 3 illustrates one such program 92 for video editing services and means in a global computer network 70 environment.

It is understood that other computer architectures and configurations (network or stand alone) are suitable for implementing the present invention.

With reference to FIG. 3, at an initial step 100, the user via a user computer 50 connects to invention portal at host computer 60. Upon connection, host computer 60 initializes a session, verifies identity of the user and the like.

Next (step 101) host computer 60 receives input or subject video data 11 transmitted (uploaded or otherwise provided) upon user command. The subject video data 11 includes corresponding audio data, multimedia and the like and may be stored in a media file. In response (step 102), host computer 60 employs a transcription module 23 that transcribes the corresponding audio data of the received video data (media file) 11 and produces a working transcript 13. Speech-to-text technology common in the art is employed in generating the working transcript from the received audio data. The working transcript 13 thus provides text of the audio corresponding to the subject (source) video data 11. Further the transcription module 23 generates respective associations between portions of the working transcript 13 and respective corresponding portions of the subject video data (media file) 11. The generated associations may be implemented as links, pointers, references or other loose data coupling techniques. In preferred embodiments, transcription module 23 inserts time stamps (codes) 33 for each portion of the working transcript 13 corresponding to the source media track, frame and elapsed time of the respective portion of subject video data 11.

Host computer 60 displays (step 104) the working transcript 13 to the user through user computers 50 and supports a user interface 27 thereof. In step 103, the user interface 27 enables the user to navigate through the displayed working transcript 13 and to select desired portions of the audio text (working transcript). The user interface 27 also enables the user to play-back portions of the source video data 11 as selected through (and viewed along side with) the corresponding portions of the working transcript 13. This provides audio-visual sampling and simultaneous transcript 13 viewing that assists the user in determining what portions of the original video data 11 to cut or use. Host computer 60 is responsive (step 105) to each user selection and command and obtains the corresponding portions of subject video data 11. That is, from a user selected portion of the displayed working transcript 13, host computer assembly member 25 utilizes the prior generated associations (from step 102) and determines the portion of original video data 11 that corresponds to the user selected audio text (working transcript 13 portion).

The user also indicates order or sequence of the selected transcript portions in step 105 and hence orders corresponding portions of subject video data 11. The assembly member 25 orders and appends or otherwise combines all such determined portions of subject video data 11 corresponding to user selected portions and ordering of the displayed working transcript 13. An edited version (known in the art as a “rough cut”)15 of the subject video data and corresponding text script 17 thereof results.

Host computer 60 displays (plays back) the resulting video work (edited version or rough cut) 15 and corresponding text script 17 to the user (step 108) through user computers 50. Preferably, host computer 60, under user command, simultaneously displays the original working transcript 13 with the resulting video work/edited (cut) version 15. In this way, the user can view the original audio text and determine if further editing (i.e., other or different portions of the subject video data 11 or a different ordering of portions) is desired. If so, steps 103, 104, 105 and 108 as described above are repeated (step 109). Otherwise, the process is completed at step 110.

Given the rough or edited cut 15, the present invention provides an audio-video transcript based video editing process using display of the corresponding text script 17 and optionally the working transcript 13 of the audio corresponding to subject source video data 11. Further, the assembly member 25 generates the rough cut and succeeding versions 15 (and respective text scripts 17) in real time of the user selecting and ordering (sequencing) corresponding working transcript 13/text script 17 portions. To assist the user in editing the rough cut 15, the present invention (host computer 60, program 92) estimates the time location (e.g., frame, hour, minutes, seconds of elapsed time) in the video data 11 of a word or other text unit in the text script 17 upon user selection of the word. The present invention calculates and displays the estimated time location of text during user editing activity (throughout steps 103, 104, 105 and 108). The displayed estimated time locations provide a visual cross-reference between the beginning and ending of user-selected portions in the text script 17 and the corresponding video-audio segment in the media file/source video data 11.

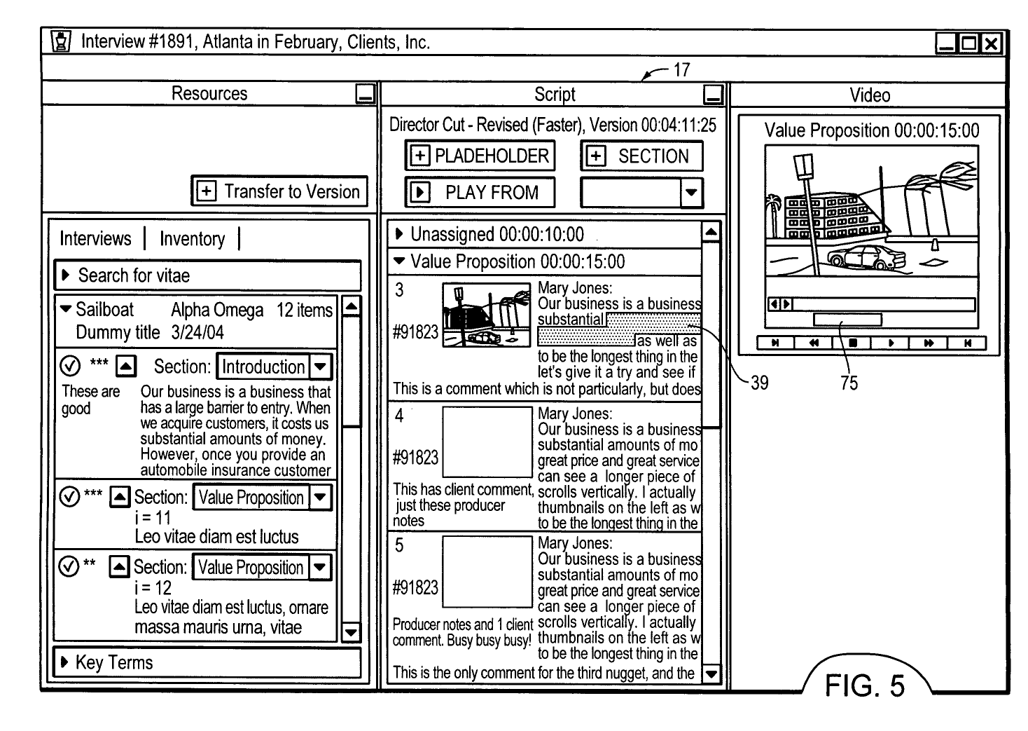

In one embodiment, a bar indicator 75 graphically illustrates the portion of video data, relative to the whole video data 11, that corresponds to the user selected text portions 39. The estimated time locations are displayed with an estimated beginning time associated with one end of the bar indicator 75 and an estimated ending time associated with the other end of the bar indicator 75. FIG. 5 is illustrative.

Preferably, the bar graphical interface operates in both directions. That is, upon a user operating (dragging/sliding) the bar indicator 75 to specify a desired portion of the video data 11, the present invention (host computer 60, program 92) highlights or otherwise indicates the corresponding resulting text script 17. Upon a user selecting text portions 39 in the working text script 17, the present invention augments (moves and resizes) the bar indicator 75 to correspond to the user selected text portions 39.

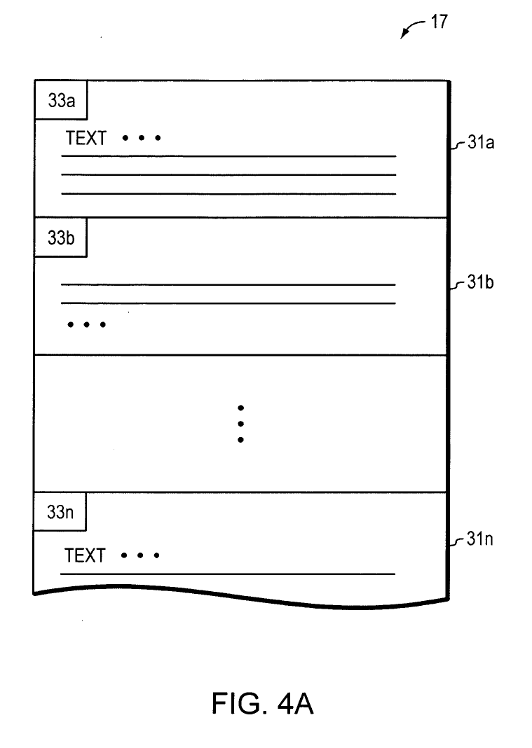

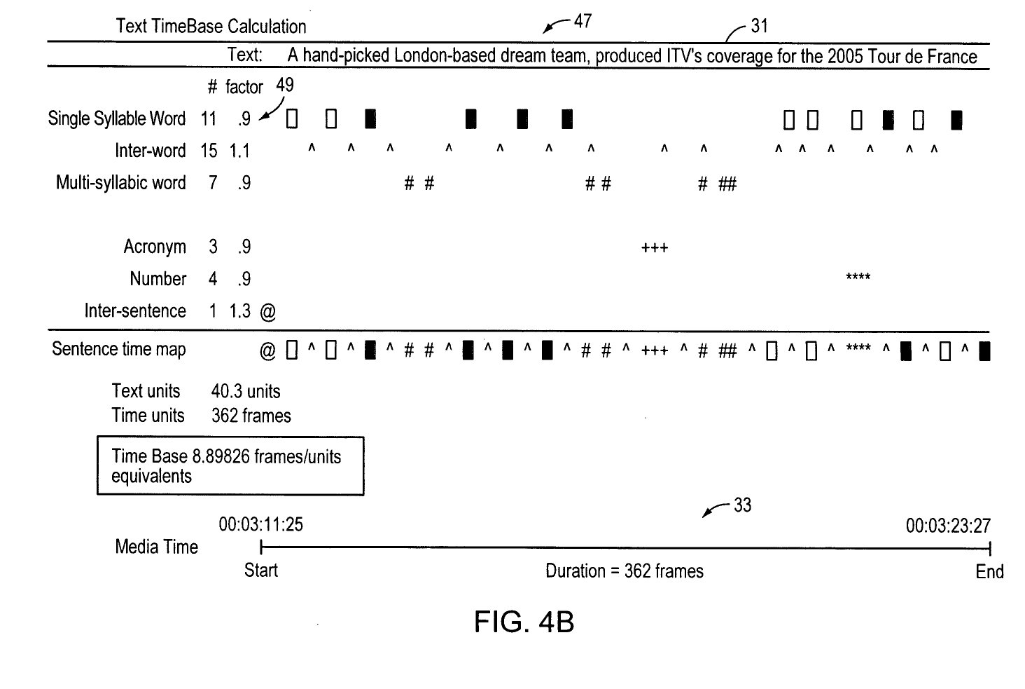

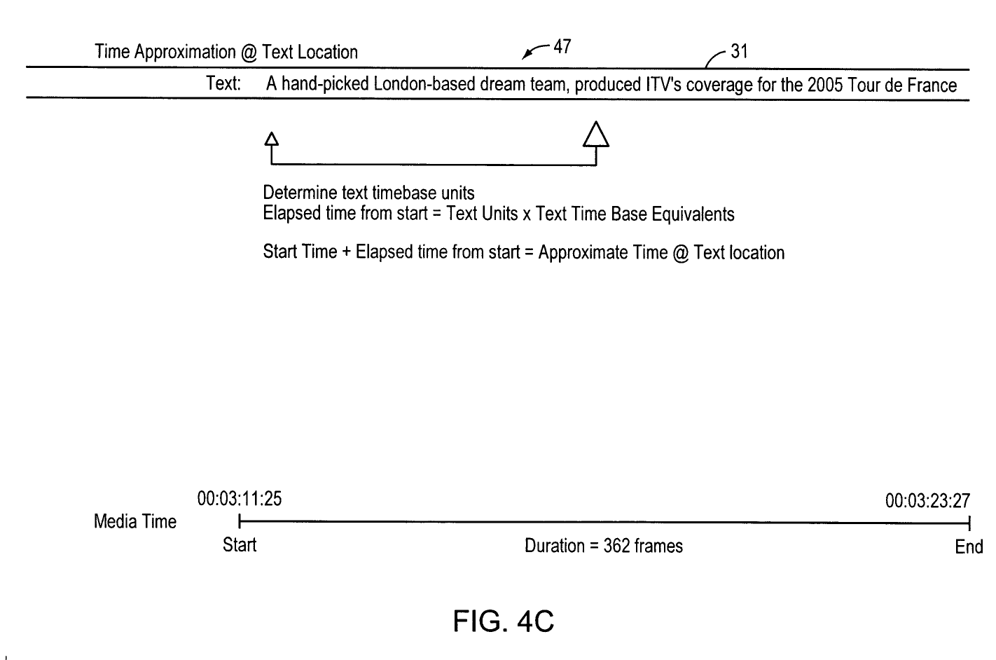

The foregoing is accomplished by the present invention generating and effecting a mapping between words (units) and sentence units of the text script 17 and time locations in the video data (media file) 11. Time approximation (in the video data 11 domain) for a text location in text scripts 17 in a preferred embodiment is illustrated in FIGS. 4a through 4c. A working text script 17 is formed of a series of passages 31a, b, . . . n. Each passage 31 is represented by a record or similar data structure in system data 94 (FIG. 2) and includes one or more statements of the corresponding videoed interview (footage). Each passage 31 is time stamped (or otherwise time coded) 33 by a start time, end time and/or elapsed time of the original media capture of the interview (footage). Elapsed time or duration of the passage 31 is preferably in units of number of frames.

For a given passage 31 (FIG. 4b), the present invention time approximator 47 counts the number of words, the number of inter-word locations, the number of syllables, the number of acronyms, the number of numbers used (recited) in the passage statements and the number of inter-sentence locations. Acronyms and numbers may be determined based on a dictionary or a database lookup. In one embodiment, the present invention 47 also determines the number of double vowels or employs other methods for identifying number of syllables (as a function of vowels or the like). Each of the above attributes is then multiplied by a respective weight (typically in the range −1 to +2). The resulting products are summed together, and the resulting sum total provides the number of text units for the passage 31.

In other embodiments, various methods may be used to determine syllable count in a subject passage 31. For example, a dictionary lookup table may be employed to cross reference a term (word) in subject passage 31 with the number of syllables therein. Other means and methods for determining a syllable count are suitable.

Next, the present invention approximator 47 defines a Time Base Equivalent (constant C) of passage 31. The time duration (number of frames) 33 of passage 31 is divided by the number of text units calculated above for the passage 31. The resulting quotient is used as the value of the Time Base Equivalent constant C.

In the example illustrated in FIG. 4b the number of single syllable words in passage 31 is 11, the number of inter-words is 15, the number of multi-syllabic words is 7, the number of acronyms is 3, the number of numbers recited in text is 4. There is 1 inter-sentence location. This accounting is shown numerically and graphically in FIG. 4b. A sentence map in FIG. 4b illustrates the graphical accounting in word sequence (sentence) order. Respective weights 49 for each attribute are listed in the column indicating “factor”. In other embodiments, the weight for double vowels is negative to effectively nullify any duplicative accounting of text units. The total number of text units is then calculated for this example as (11×0.9)+(15×1.1)+(7×0.9)+(3×0.9)+(4×0.9)+(1×1.3)=40.3.

Time duration of illustrated passage 31 is 362 frames as shown at 33 in FIG. 4b. Dividing the above calculated 40.3 text units by 362 frames produces a Time Base Equivalent of 8.898 frames/unit (used as constant C below).

The produced Time Base Equivalent constant is then used as follows to calculate the approximate time occurrence (in the source video data 11) of a user-selected word text script 17.
Elapsed time from start=Text Units×C where C is the above defined Time Base Equivalent constant. (Eq. 1)
Start time of passage 31+Elapsed time from start=Approximate Time at text location (Eq. 2)

FIG. 4c is illustrative where the approximate time in media time (video data 11 domain) of the term “team” in corresponding text script 17/passage 31 of the example is sought. For each word or linguistic unit from the beginning of passage 31 through the subject term “team”, the present invention approximator 47 counts the number of single syllable words, inter-words, multi-syllabic words, acronyms, numbers, and inter-sentences. For each of these attributes, the determined count is multiplied by the respective weight 49 (given in FIG. 4b), and the sum of these products generates a working text unit. According to Eq. 1, the working text units multiplied by the Time Base Equivalent constant (8.898 detailed above) produces an elapsed time from start. According to Eq. 2, that elapsed time from start is added to the passage 31 start time of 3:11:25 (in the illustrated example) to produce an estimated or approximate time of the subject term “team”.

Likewise, time approximation of a second user selected word at a location spaced apart from the term “team” (e.g., at the end of a desired statement, phrase, subset thereof) in passage 31 may be calculated. In this manner, estimated beginning time and ending time of the user selected passage 31 subset defined between “team” and the second user selected word are produced.

In turn, the present invention displays the computed estimated times of user selected terms (begin time and end time of passage subsets) as described above and illustrated in FIG. 5. Throughout the editing process, the user can interpret elapsed amounts of time per passages 31 based on the displayed estimated times.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a client server architecture in a local area or wide area network instead of the global network 70. Alternatively, given the foregoing, other embodiments may include a stand alone, desktop or local processor implementation of the present invention time approximation for text location in video editing.

In some embodiments, the weights (multipliers) 49 for each attribute in the approximator 47 computations are user-adjustable. The graphical user interface in FIG. 5 may provide “buttons” or other user-selectable means to adjust weight 49 values.

Further, the disclosed invention approximation of text location corresponding to a source video may be used for other purposes than video editing. Other video processing, indexing, captioning and the like are examples of further purposes and uses of the present invention time approximation of text location.

What is claimed is:

1. In a video editing system having video data and a text transcript of audio corresponding to the video data, the text transcript being formed of one or more passages, a time approximator comprising:
for each passage in the text transcript, a respective text based equivalent defined for the passage;
a counter member for counting attributes in a subject passage, the counter member counting attributes from a start of the subject passage to a user-selected term in the subject passage; and
a processor routine responsive to user selection of the term in the subject passage, the processor routine calculating an estimated time of occurrence in the video data of the user-selected term as a function of the counted attributes and the text based equivalent of the subject passage.

2. A time approximator as claimed in claim 1 wherein the processor routine calculates the estimated time of occurrence by:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce an estimated time of occurrence in the video data of the user-selected term.

3. A time approximator as claimed in claim 1 wherein the counter member further counts attributes in the subject passage for defining the text based equivalent.

4. A time approximator as claimed in claim 1 wherein the attributes include words, syllables, acronyms, numbers, double vowels and/or inter-sentence locations.

5. A computer system for video editing comprising:
means for receiving subject video data, the subject video data including corresponding audio data;
means for transcribing the corresponding audio data of the subject video data, the transcribing means generating a working transcript of the corresponding audio data and associating portions of the working transcript to respective corresponding portions of the subject video data;
means for displaying the working transcript to a user and enabling user selection of portions of the subject video data through the displayed working transcript, the display and user selection means including for each user selected transcript portion from the displayed working transcript, in real time, (i) obtaining the respective corresponding video data portion, (ii) combining the obtained video data portions to form a resulting video work and (iii) displaying the resulting video work to the user upon user command during user interaction with the displayed working transcript; and
time approximation means coupled to the display and user-selection means, the time approximation means calculating for display an estimated time of occurrence in the video data of the audio data corresponding to the user-selected transcript portion.

6. A computer system as claimed in claim 5 wherein the working transcript is formed of one or more passages, and
the time approximation means comprises:
for each passage in the working transcript, a respective text based equivalent defined for the passage;
a counter member for counting attributes in a subject passage, the counter member counting attributes from a start of the subject passage to a user-selected term in the subject passage; and
a processor routine responsive to user selection of the term in the subject passage, the processor routine calculating an estimated time of occurrence in the video data of the user-selected term as a function of the counted attributes and the text based equivalent of the subject passage.

7. A computer system as claimed in claim 6 wherein the processor routine calculates the estimated time of occurrence by:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce an estimated time of occurrence in the video data of the user-selected term.

8. A computer system as claimed in claim 6 wherein the counter member further counts attributes in the subject passage for defining the text based equivalent.

9. A computer system as claimed in claim 6 wherein the attributes include words, syllables, acronyms, numbers, double vowels and/or inter-sentence locations.

10. In a network of computers formed of a host computer and a plurality of user computers coupled for communication with the host computer, a method of editing video comprising the steps of:
receiving a subject video data at the host computer, the video data including corresponding audio data;
transcribing the received subject video data to form a working transcript of the corresponding audio data;
associating portions of the working transcript to respective corresponding portions of the subject video data;
displaying the working transcript to a user and enabling user selection of portions of the subject video data through the displayed working transcript, said user selection including sequencing of portions of the subject video data;
for a user selected transcript portion from the displayed working transcript, calculating for display an estimated time of occurrence in the video data of the audio data corresponding to the user-selected transcript portion; and
displaying the calculated estimated time of occurrence in a manner enabling a user to cross reference between a beginning and ending of the user-selected transcript portion and the corresponding video data.

11. A method as claimed in claim 10 further comprising, for the user-selected transcript portion, in near real time, (i) obtaining the respective corresponding video data portion and (ii) combining the obtained video data portions to form a rough video cut and succeeding video cuts, the resulting rough video cut and succeeding video cuts having respective corresponding text scripts; and
providing display of the rough video cut and succeeding video cuts to the user during user interaction with the displayed working transcript.

12. A method as claimed in claim 11 further comprising the step of providing respective display of the text scripts corresponding to the rough video cut and the succeeding video cuts.

13. A method as claimed in claim 10 wherein the working transcript is formed of one or more passages; and
the step of calculating includes:
for each passage in the working transcript, obtaining a respective text based equivalent defined for the passage,
counting attributes in a subject passage from a start of the subject passage to a user selected term in the subject passage, and
determining an estimated time of occurrence in the video data of the user selected term as a function of the counted attributes and the text based equivalent of the subject passage.

14. A method as claimed in claim 13 wherein the step of determining an estimated time of occurrence includes:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce an estimated time of occurrence in the video data of the user-selected term.

15. A method as claimed in claim 13 wherein the step of obtaining a respective text based equivalent utilizes the counted attributes in the subject passage.

16. A method as claimed in claim 13 wherein the attributes include words, syllables, acronyms, numbers, double vowels and/or inter-sentence locations.

17. A method for approximating time location of text in a text transcript of audio, comprising the computer implemented steps of:
for each passage in the text transcript, defining a respective text based equivalent for the passage;
counting attributes in a subject passage, said counting being from a start of the subject passage to a user-selected term in the subject passage; and
for audio having a corresponding video data, in response to user selection of the term in the subject passage, calculating an estimated time of occurrence in the video data of the user-selected term as a function of the counted attributes and the text based equivalent of the subject passage.

18. A method as claimed in claim 17 wherein the step of calculating calculates the estimated time of occurrence by:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce an estimated time of occurrence in the video data of the user-selected term.

19. A method as claimed in claim 17 wherein the step of counting further counts attributes in the subject passage for defining the text based equivalent.

20. A method as claimed in claim 17 wherein the attributes include words, syllables, acronyms, numbers, double vowels and/or inter-sentence locations.
